(19) United States
(12) Patent Application Publication
(10) Pub. No.: US 2016/0188851 A1
(43) Pub. Date: Jun. 30, 2016

(54) COMPUTER HOST AND COMPUTER SYSTEM INCLUDING THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: KAI-LE ZHAI, Wuhan (CN); CHUN-SHENG CHEN, New Taipei (TW)

(21) Appl. No.: 14/691,114

(22) Filed: Apr. 20, 2015

(30) Foreign Application Priority Data
Dec. 30, 2014 (CN) 201410841148.8

(51) Int. Cl. G06F 21/31; G06F 21/77; G06F 21/62

(52) U.S. Cl. CPC G06F 21/31; G06F 21/6218; G06F 21/77

(57) ABSTRACT

The disclosure provides a computer host including a south bridge chipset, an inductive circuit, a memory, and a processor. The inductive circuit obtains an identity information of an identification card. The memory device can store an authentication information. The processor obtains the identity information from the identification card and the authentication information from the memory device, and configured to compare the identity information with the authentication information. When the identity information of the identification card matches with the authentication information of the memory device, the computer is activated. The disclosure also provides a computer system including the computer host.

### FIELD

The subject matter herein generally relates to a computer system, and particularly relates to a computer system including a computer host.

### BACKGROUND

Typically, computers must be physically inaccessible to unauthorized users to prevent confidential information loss.

### BRIEF DESCRIPTION OF THE DRAWINGS

Implementations of the present technology will now be described, by way of example only, with reference to the attached figures.

FIG. 1 is a block diagram of an embodiment of a computer system of the present disclosure, the computer system comprises a computer host.

FIG. 2 is a block diagram of an embodiment of a computer host of the present disclosure.

FIG. 3 is a circuit diagram of the computer host of the FIG. 2.

FIG. 4 is a circuit diagram of the computer host of the FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrates details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

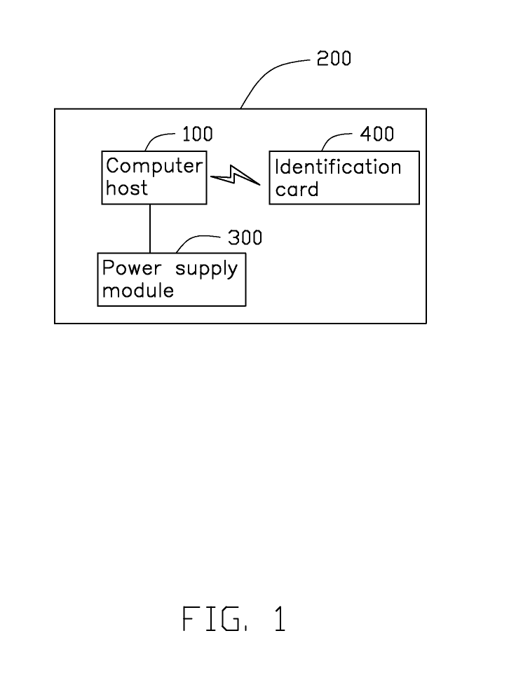

FIG. 1 illustrates an embodiment of a computer system 200 of the present disclosure. The computer system 200 can comprise a computer host 100, a power supply module 300, and an identification card 400. The power supply module 300 can provide +3.3V, +3.3V_VDD, +5V, and +1.5V power supply for the computer host 100. The identification card 400 can store identity information of a user.

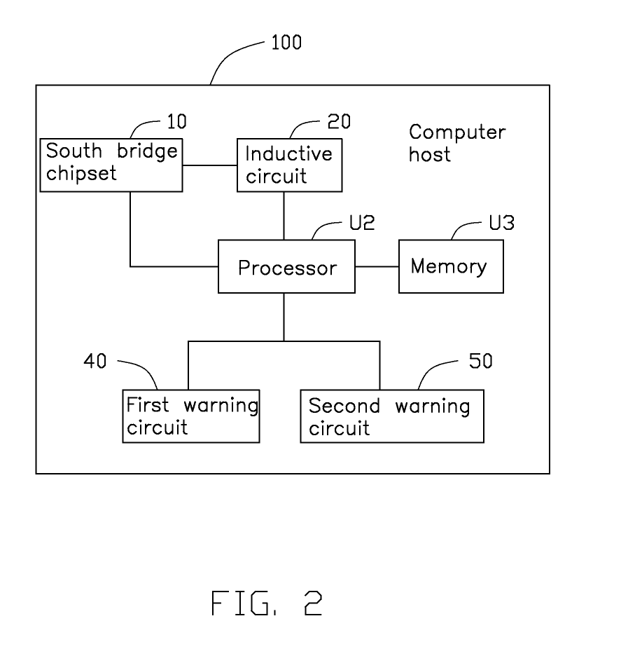

FIG. 2 illustrates an embodiment of the computer host 100. The computer host 100 can comprise a south bridge chipset 10, an inductive circuit 20, a memory U3, a first warning circuit 40, a second warning circuit 50, and a processor U2. Both the south bridge chipset 10 and the inductive circuit 20 are electrically coupled to the processor U2. The south bridge chipset 10 is electrically coupled to the inductive circuit 20. The first warning circuit 10, the second warning circuit 50, and the memory U3 are electrically coupled to the processor U2, respectively.

In at least one embodiment, the memory U3 can store an authentication information.

In at least one embodiment, the inductive circuit 20 obtains the identity information from the identification card 400, and transmits the identity information to the processor U2.

In at least one embodiment, the processor U2 obtains the identity information from the inductive circuit 20 and the authentication information from the memory U3, and compares the identity information with the authentication information and gets a comparison result, and outputs a first warning signal to the first warning circuit 40 or outputs a second warning signal to the second warning circuit 50 according to the comparison result.

In at least one embodiment, the first warning circuit 40 outputs a first warning information according to the first warning signal transmitted by the processor U2. The second warning circuit 50 outputs second warning information according to the second warning signal transmitted by the processor U2.

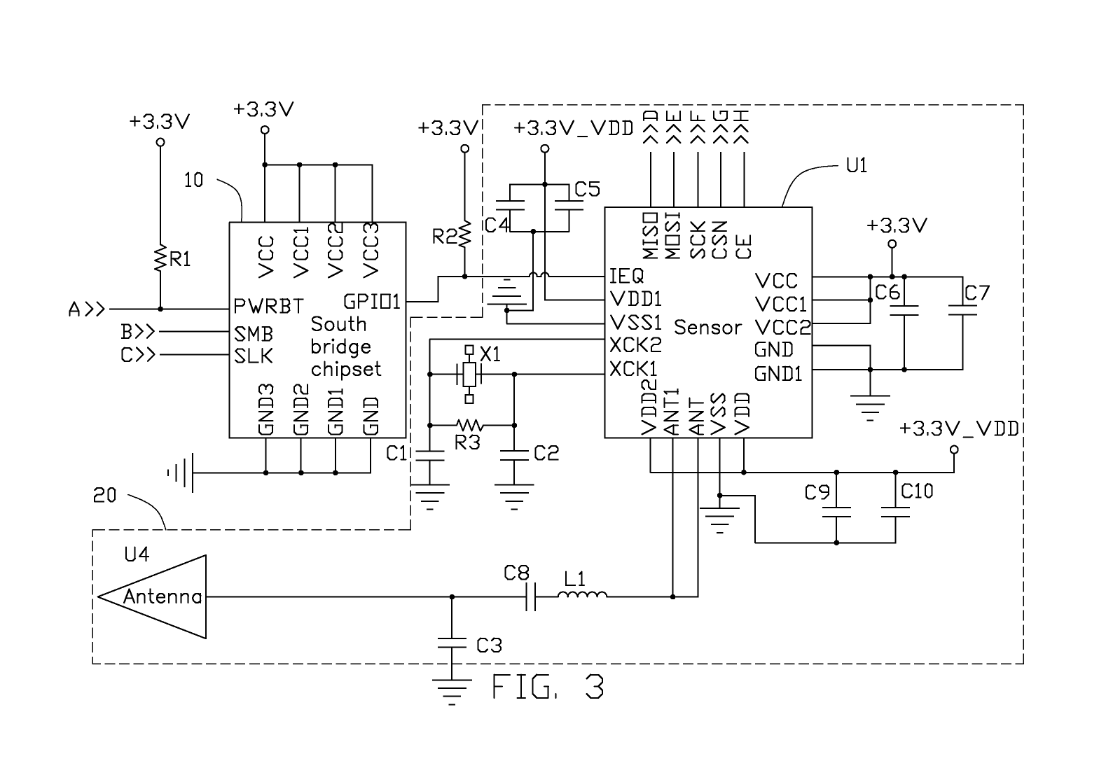

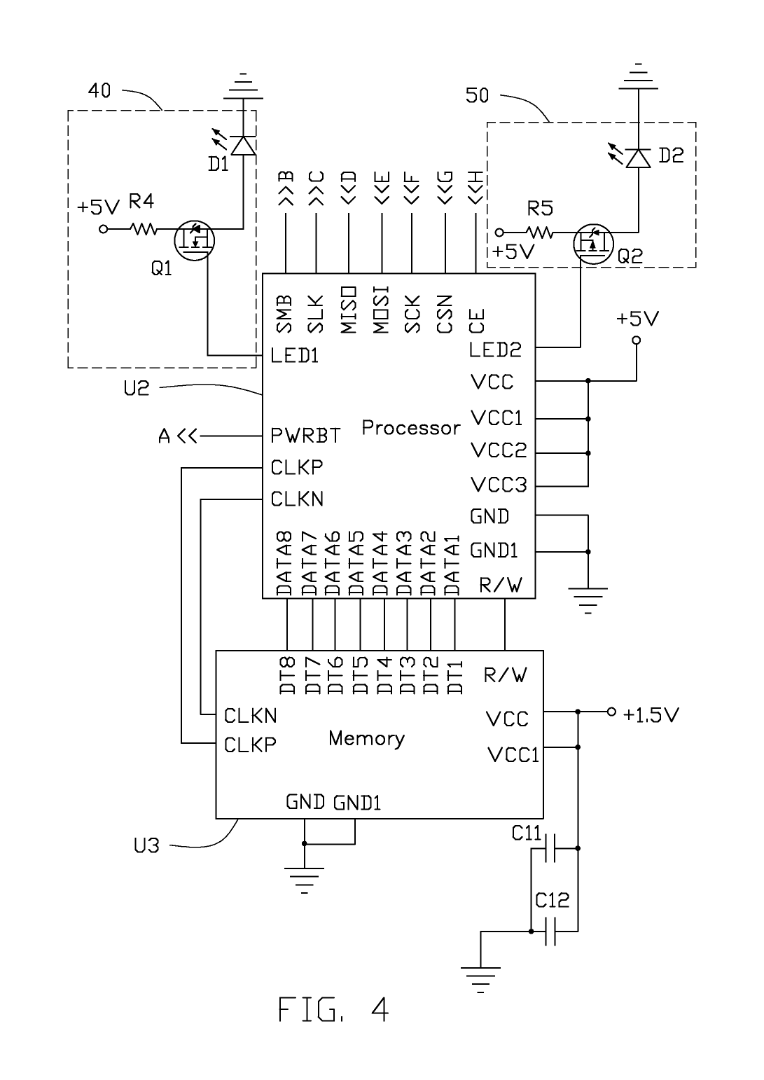

FIGS. 3 and 4 illustrate a circuit diagram of the computer host. Four power supply pins VCC-VCC3 of the south bridge chipset 10 are electrically coupled to the power supply +3.3V. Four ground pins GND-GND3 of the south bridge chipset 10 are electrically coupled to a ground. A power switch pin PWRBT of the south bridge chipset 10 is electrically coupled to the power supply +3.3V through a resistor R1. A detect pin GPIO1 of the south bridge chipset 10 is electrically coupled to the power supply +3.3V through a resistor R2.

The inductive circuit 20 can comprise a sensor U1, an antenna U4, an inductor L1, ten capacitors C1-C10, and a crystal oscillator X1. A first clock pin XCK1 of the sensor U1 is electrically coupled to a first terminal of the crystal oscillator X1, and is electrically coupled to the ground through the capacitor C1. A second clock pin XCK2 of the sensor U1 is electrically coupled to a second terminal of the crystal oscillator X1, and is electrically coupled to the ground through the capacitor C2. The resistor R3 is electrically coupled to the crystal oscillator X1 in parallel. A detect pin GPIO1 of the south bridge chipset 10 is electrically coupled to a signal pin IEQ of the sensor U1. A power supply pin VSS1 of the sensor U1 is electrically coupled to the ground, and coupled to the power supply +3.3V_VDD through the capacitor C4. The capacitor C5 is electrically coupled to the capacitor C4 in parallel. A power supply pin VDD1 of the sensor U1 is electrically coupled to the power supply +3.3V_VDD. Three power supply pins VCC, VCC1, VCC2 of the sensor U1 are electrically coupled to the power supply +3.3V. The power supply +3.3V is electrically coupled to the ground through the capacitor C6, and the capacitor C6 is electrically coupled to the capacitor C7 in parallel. Two ground pins GND and GND1 of the sensor U1 are electrically coupled to the ground. Two induce pins ANT and ANT1 of the sensor U1 is electrically coupled to the antenna U4 through the inductor L1 and capacitor C8, to receive the identity information from the identification card 400. A node between the capacitor C8 and the antenna U4 is electrically coupled to the ground through the capacitor C3. Two power supply pins VDD and VDD2 of the sensor U1 are electrically coupled to the power supply +3.3V_VDD, and are electrically coupled to the ground through the capacitor C9. The capacitor C9 is electrically coupled to the capacitor C10 in parallel. A power supply pin VSS of the sensor U1 is electrically coupled to ground.

Four power supply pins VCC-VCC3 of the processor U2 are electrically coupled to the power supply +5V. Two ground pins GND and GND1 of the processor U2 are electrically coupled to the ground. Five data pins CE, CSN, SCK, MOSI, and MISO of the processor U2 are electrically coupled to five data pins CE, CSN, SCK, MOSI, and MISO of the sensor U1, respectively, to receive the identity information from the sensor U1. Two signal pins SLK, SMB and a power switch pin PWRBT of the processor U2 are electrically coupled to the two signal pins SLK, SMB and a power switch pin PWRBT of the south bridge chipset 10, respectively, to output a boot control signal to the south bridge chipset 10. A first warning pin LED1 of the processor U2 is electrically coupled to the first warning circuit 40. A second warning pin LED2 of the processor U2 is electrically coupled to second warning circuit 50.

The first warning circuit 40 can comprise a resistor R4, a light-emitting diode (LED) D1, and a field effect transistor (FET) Q1. A source of the FET Q1 is electrically coupled to the power supply +5V through the resistor R4. A gate of the FET Q1 is electrically coupled to the first warning pin LED1 of the processor U2. A drain of the FET Q1 is electrically coupled to an anode of the LED D1. A cathode of the LED D1 is electrically coupled to the ground.

The second warning circuit 50 can comprise a resistor R5, a LED D2, and a FET Q2. A drain of the FET Q2 is electrically coupled to the power supply +5V through the resistor R5. A gate of the FET Q2 is electrically coupled to the second warning pin LED2 of the processor U2. A source of the FET Q2 is electrically coupled to an anode of the LED D2. A cathode of the LED D2 is electrically coupled to the ground. The LEDs D1 and D2 respectively emit green and red light.

Two ground pins GND and GND1 of the memory U3 are electrically coupled to the ground. Two power supply pins VCC and VCC1 of the memory U3 are electrically coupled to the power supply +1.5V, and are electrically coupled to the ground through a capacitor C12. The capacitor C12 is electrically coupled to a capacitor C11 in parallel. Two clock pins CLKP, CLKN, a control pin R/W, and eight data pins DT1-DT8 of the memory U3 are respectively coupled to two clock pins CLKP, CLKN, a control pin R/W, and eight data pins DATA1-DATA8 of the processor U2.

When the identification card 400 is closed to the antenna U4 of the inductive circuit 20, and the distance between the identification card 400 and the antenna U4 is probably 10 centimeters, the antenna U4 obtains the identity information from the identification card 400, and transmits the identity information to the induce pins ANT and ANTI of the sensor U1. The sensor U1 transmits the identity information to the processor U2. At the same time, the processor U2 obtains the authentication information from the memory U3, and compares the identity information with the authentication information.

When the identity information of the identification card 400 matches with the authentication information of the memory U3, the processor U2 outputs the boot control signal with low level to the south bridge chipset 10, and the computer will be turned on. At the same time, the first warning pin LED1 of the processor U2 outputs a first warning signal with low level to the FET Q1, the FET Q1 is turned on, and the LED D1 emits light, to show the identification card 400 is authorized.

When the identity information of the identification card 400 does not match with the authentication information of the memory U3, the processor U2 outputs the boot control signal with high level to the south bridge chipset 10, and the computer will not turn on. At the same time, the second warning pin LED D2 of the processor U2 outputs a second warning signal with low level to the FET Q2, the FET Q2 is turned on, and the LED D2 emits light, to show the identification card 400 is not authorized.

In at least one embodiment, the south bridge chipset 10 can write authentication information to the memory U3, to increase the recognition of identity information needed for access to the computer.

In the embodiment, the identification card 400 can be a radio frequency (RF) card. In other embodiments, the identification card 400 can be a magnetic card or an integrated circuit (IC) card.

The embodiments shown and described above are only examples. Many details are often found in the art such as the other features of the computer system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A computer host comprising:
an inductive circuit configured to electronically receive identity information from a computer user identity card;
a south bridge chipset connected to the inductive circuit;
a processor connected to the inductive circuit and to the south bridge chipset; and
a memory device connected to the processor, the memory device electronically storing authentication information;
wherein, the inductive circuit electronically receives the identity information from the user identity card and transmits the identity information to the processor;
wherein, the processor obtains the authentication information from the memory device and compares the identity information to the authentication information;
wherein, if the processor determines that the identity information matches the authentication information, the processor outputs a first boot control signal to the south bridge chipset activating the hosted computer; and
wherein, if the processor determines that the identity information does not match the authentication information, the processor outputs a second boot control signal to the south bridge chipset and the hosted computer is not activated.

2. The computer host of claim 1, further comprising:
a first warning circuit connected to the processor; and
a second warning circuit connected to the processor;
wherein, when the processor determines that the identity information matches the authentication information, the processor transmits a warning signal to the first warning circuit causing the first warning circuit to output a first warning information; and
wherein, when the processor determines that the identity information does not match the authentication information, the processor transmits a second warning signal to the second warning circuit causing the second warning circuit to output a second information.

3. The computer host of claim 2, wherein the first warning circuit further comprises a first light-emitting diode (LED), a first field effect transistor (FET), and a first resistor, the second warning circuit further comprises a second LED, a second FET, and a second resistor, a cathode of the first LED is electrically coupled to the ground, an anode of the first LED is electrically coupled to a drain of the first FET, a source of the first FET is electrically coupled to a first power supply through the first resistor, a gate of the first FET is electrically coupled to a first warning pin of the processor, a cathode of the second LED is electrically coupled to ground, an anode of the second LED is electrically coupled to a source of the second FET, a drain of the second FET is electrically coupled to the first power supply through the second resistor, and a gate of the second FET is electrically coupled to a second warning pin of the processor.

4. The computer host of claim 3, wherein first, second, third and fourth power supply pins of the south bridge chipset are electrically coupled to a second power supply, first, second, third and fourth ground pins of the south bridge chipset are electrically coupled to the ground, a first signal pin and a second signal pin of the south bridge chipset are electrically coupled to a first signal pin and a second signal pin of the processor, respectively, a detect pin of the south bridge chipset is electrically coupled to the inductive circuit, a power supply switch pin of the south bridge chipset is electrically coupled to a power supply switch pin of the processor, and is electrically coupled to the second power supply through a third resistor.

5. The computer host of claim 1, wherein the identification card is a radio frequency (RF) card.

6. The computer host of claim 1, wherein the identification card is a magnetic card.

7. The computer host of claim 1, wherein the identification card is an integrated circuit (IC) card.

8. A computer system comprising:
a user identity card storing a identity information;
an inductive circuit configured to electronically receive identity information from the computer user identity card;
a south bridge chipset connected to the inductive circuit;
a processor connected to the inductive circuit and to the south bridge chipset; and
a memory device connected to the processor, the memory device electronically storing authentication information;
wherein, the inductive circuit electronically receives the identity information from the user identity card and transmits the identity information to the processor;
wherein, the processor obtains the authentication information from the memory device and compares the identity information to the authentication information;
wherein, if the processor determines that the identity information matches the authentication information, the processor outputs a first boot control signal to the south bridge chipset activating the hosted computer; and
wherein, if the processor determines that the identity information does not match the authentication information, the processor outputs a second boot control signal to the south bridge chipset and the hosted computer is not activated.

9. The computer system of claim 8, further comprising:
a first warning circuit connected to the processor; and
a second warning circuit connected to the processor;
wherein, when the processor determines that the identity information matches the authentication information, the processor transmits a warning signal to the first warning circuit causing the first warning circuit to output a first warning information; and
wherein, when the processor determines that the identity information does not match the authentication information, the processor transmits a second warning signal to the second warning circuit causing the second warning circuit to output a second information.

10. The computer system of claim 9, wherein the first warning circuit further comprises a first light-emitting diode (LED), a first field effect transistor (FET), and a first resistor, the second warning circuit further comprises a second LED, a second FET, and a second resistor, a cathode of the first LED is electrically coupled to the ground, an anode of the first LED is electrically coupled to a drain of the first FET, a source of the first FET is electrically coupled to a first power supply through the first resistor, a gate of the first FET is electrically coupled to a first warning pin of the processor, a cathode of the second LED is electrically coupled to ground, an anode of the second LED is electrically coupled to a source of the second FET, a drain of the second FET is electrically coupled to the first power supply through the second resistor, and a gate of the second FET is electrically coupled to a second warning pin of the processor.

11. The computer system of claim 10, wherein first, second, third and fourth power supply pin of the south bridge chipset are electrically coupled to a second power supply, first, second, third and fourth ground pin of the south bridge chipset are electrically coupled to the ground, a first signal pin and a second signal pin of the south bridge chipset are electrically coupled to a first signal pin and a second signal pin of the processor, respectively, a detect pin of the south bridge chipset is electrically coupled to the inductive circuit, a power supply switch pin of the south bridge chipset is electrically coupled to a power supply switch pin of the processor, and is electrically coupled to the second power supply through a third resistor.

12. The computer system of claim 8, wherein the identification card is a radio frequency (RF) card.

13. The computer system of claim 8, wherein the identification card is a magnetic card.

14. The computer system of claim 8, wherein the identification card is an integrated circuit (IC) card.
